(19) United States
(12) Patent Application Publication
(10) Pub. No.: US 2026/0183774 A1
(43) Pub. Date: Jul. 2, 2026

(54) DEVICE AND METHOD FOR CONTROLLING CHARGED PARTICLES IN FLUID

(71) Applicant: ZHUHAI JIEYI BIOTECHNOLOGY SCIENCE AND TECHNOLOGY CO., LTD, Zhuhai (CN)

(72) Inventors: Shaojun YANG, Zhuhai (CN); Yiyi LI, Zhuhai (CN)

(21) Appl. No.: 19/440,543

(22) Filed: Jan. 5, 2026

Related U.S. Application Data
(63) Continuation of application No. PCT/CN2023/102676, filed on Jun. 27, 2023.

(30) Foreign Application Priority Data
Jul. 7, 2022 (CN) 202210803966.3

(51) Int. Cl. B03C 5/02; B01L 3/00; B03C 5/00

(52) U.S. Cl. CPC B03C 5/028; B01L 3/502761; B03C 5/005; B01L 2200/0647; B01L 2300/0645

(57) ABSTRACT

A device for controlling charged particles in a fluid, including a microfluidic channel, at least three electrodes, a plurality of conductor leads and at least two drive power supplies. The drive power supplies can periodically produce a voltage or current excitation varying within a cycle, and are connected to at least one of the electrodes via the conductor leads. Each electrode is configured to continuously undergo charging-discharging alternating cycles to form a traveling-wave electric field with a periodically-varying amplitude in the microfluidic channel. A maximum charge capacity of the electrode is greater than a total amount of charges transferred thereon during a charging or discharging process. A charged particle control method is also provided.

### CROSS-REFERENCE TO RELATED APPLICATIONS

This application is a continuation of International Patent Application No. PCT/CN2023/102676, filed on Jun. 27, 2023, which claims the benefit of priority from Chinese Patent Application No. 202210803966.3, filed on Jul. 7, 2022. The content of the aforementioned application, including any intervening amendments made thereto, is incorporated herein by reference in its entirety.

### TECHNICAL FIELD

This application relates to operation and control of charged particles in electrolytes, and more particularly to a device and method for controlling charged particles in a fluid.

### BACKGROUND

Charged particles in a liquid or colloid sample are forced to move under the action of an electric field. Therefore, by introducing an electric current into a liquid or colloidal electrolyte to form an electric field, it is feasible to manipulate and control the fluid or charged particles therein.

Currently, the methods to introduce the electric current into the fluid mainly involves the use of a conductor electrode, such as a graphite electrode, an alloy electrode or a solid metal (e.g., gold and platinum).

During the operation of the conductor electrode, the carriers in an electrolyte solution are ions, while the carriers in the conductor electrode are electrons. Therefore, an electrochemical reaction will inevitably occur at the electrode-fluid interface due to the charge transfer of the carriers. Accompanied by the development of the electrochemical reaction, bubbles will be generated, and cannot be eliminated during the operation of the conductor electrode. Particularly, in a typical aqueous working fluid, hydrogen ions near the cathode will accept electrons to produce hydrogen gas, and oxygen ions near the anode will lose electrons to produce oxygen gas. In a microchannel fluidic system, the bubbles will cause a dramatic change in the local fluid pressure due to the scale effect, thereby leading to obstruction or various adverse effects on the transport, monitoring and control of the microfluid. Local bubbles are a primary cause of microfluidic chip failures. In addition, the bubbles generated by the electrochemical reaction will be gathered around the electrode, causing a decline in the electrode conductivity as well as additional energy consumption. In an electrolyte system involving various particles, more complex electrochemical reactions will occur, thereby significantly affecting pH of the working environment. These uncontrollable factors all seriously restrict the use of the conductor electrodes.

In the technical solutions disclosed by U.S. Pat. No. 6,890,409 B2, the electrode is separated from the microchannel to prevent the bubbles from entering the microfluid. However, this solution involves an additional channel to separate the bubbles generated by the electrode from the microchannel, and thus is not suitable for a sealed fluidic channel.

International patent publication No. 2011102801 A1 discloses an electrode made from a pseudo-capacitive material based on a pi-conjugated complex, where by means of the reversible redox reaction of the conjugated complex, the electrochemical reaction at the interface between the solid electrode and the fluid electrolyte can be eliminated, thereby fundamentally solving the problem of bubble generation. However, the pseudo-capacitive material stores energy primarily through reversible redox reactions that occur at the surface of the electrode material, so that it often needs to activate the electrode in advance during use. Specifically, the pseudo-capacitive material-based electrode is oxidized or reduced while serving as cathode or anode (equivalent to charging the electrochemical capacitor), thereby making its operation more complicated. In addition, the charged electrode has a certain discharge capacity, and once the discharge capacity exceeds the electrode capacity, the electrode will undergo an electrolysis reaction. Therefore, such electrode fails to support the prolonged and continuous operation or requires a larger electric current.

Chinese patent No. 100455328 C discloses a cell wall electroporation method using a pulsed electric field offered by a waveform generator, in which the electric field generated between multiple parallel electrodes is used to achieve the cell wall electroporation. Through the excitation of reciprocating current between the electrodes, an alternating electric field is generated to minimize the electrode-electrolysis reaction. However, this method cannot avoid the carrier transfer process between the electrode and the electrolyte (i.e., the electrolysis reaction), the practical application and effect are greatly limited.

Chinese patent No. 1181337 C discloses a method and kit for controlling microparticles in the liquid by using dielectrophoresis and traveling-wave electric field, where based on migration characteristics of the particles in the presence of a traveling-wave electric field, the microparticles in the liquid are controlled by said electric field generated on a microelectrode array. The controlled particles can be cells, bacteria, viruses, biomolecules, plastic microspheres or bubbles. The dielectrophoresis is performed based on the force applied to charged particles in a non-uniform electric field to reach the control effect, such that there is no need for an external driving current, thereby eliminating the electrode-electrolysis reaction. However, since the electrolyte is electrically conductive, an extremely-high electric field gradient is needed in the fluid to effectively control the charged particles therein, which will seriously limit the practical application of this technical solution. Typically, the dielectrophoresis fails to effectively control submicron-scale particles.

In summary, the existing technologies struggle with the following drawbacks.
(1) Ordinary electrodes suffer from the electrode-electrolysis reaction and resultant adverse effects, which greatly limits the application in microfluidic channel systems. For example, the ordinary electrode driven by the high-frequency traveling-wave is a temporary solution with limited use scenarios.
(2) The pseudo-capacitive material-based electrode struggle with the capacitive charge limitation, making it difficult for the traditional electrophoresis methods to meet requirements for continuous and long-term operation.
(3) Traveling-wave dielectrophoresis requires a high electric field gradient in the conductive electrolyte, which significantly limits the application range and reduces the use efficiency. Moreover, it cannot offer effective control for the nanoparticles.

### SUMMARY

An object of the present disclosure is to provide a device and method for controlling charged particles in a fluid to address the above problems in the prior art.

In order to achieve the above object, the following technical solutions are adopted.

A device for controlling charged particles in a fluid, comprising:
a microfluidic channel;
at least three electrodes;
a plurality of conductor leads; and
at least two drive power supplies;
wherein the microfluidic channel is provided with a first port and a second port; the first port and the second port are configured to allow the fluid to flow from the first port towards the second port; and the fluid contains the charged particles;
each of the at least three electrodes is in electrical contact with the fluid to form a pseudo-capacitance, a double-layer capacitance or a combination thereof at a fluid-electrode interface; the at least three electrodes are arranged in parallel on the same side or opposite sides of the microfluidic channel; and an arrangement direction of the at least three electrodes is neither parallel nor perpendicular to a flow direction of the fluid;
each of the at least two drive power supplies is configured to periodically output a voltage excitation or a current excitation; the voltage excitation or the current excitation is configured to dynamically vary within a single output period; and each of the at least two drive power supplies is connected to at least one electrode among the at least three electrodes via the at least one conductor lead among the plurality of conductor leads; and
each of the at least three electrodes is configured to continuously undergo alternating cycles of charging and discharging to form a traveling-wave electric field with a periodically-varying amplitude in the microfluidic channel; the traveling-wave electric field is configured to move at a preset traveling-wave propagation speed, and apply a force to the charged particles to generate a migration velocity perpendicular to the flow direction of the fluid, wherein the migration velocity is correlated with a charge-to-mass-ratio of the charged particles; and a maximum charge capacity of each of the at least three electrodes is greater than a total amount of charges transferred thereon during a single charging or discharging process.

In an embodiment, the fluid comprises a buffer solution and a heterogeneous fluid.

In an embodiment, the first port comprises a first inlet and a second inlet; the first inlet is configured to allow the buffer solution to flow into the microfluidic channel; the second inlet is configured to allow the heterogeneous fluid to flow into the microfluidic channel; and the first inlet is arranged above the second inlet.

In an embodiment, the second port comprises a first outlet and a second outlet; the first outlet is configured to discharge a charged particle-enriched product; the second outlet is configured to discharge a waste liquid; and the first outlet is arranged above the second outlet.

In an embodiment, the microfluidic channel has an inner diameter ranging from 100 nm to 10 mm.

In an embodiment, the charged particles each have a diameter ranging from 0.1 nm to 0.1 mm.

In an embodiment, within one or more cycles of the traveling-wave electric field, for each of the at least three electrodes, a total input current is equal to a total output current, indicating that a net input current and a net output current on each of the at least three electrodes are both zero; or
for each of the at least three electrodes, a total input charge and a total output charge are always less than the maximum charge capacity.

In an embodiment, each of the at least two drive power supplies are configured to be adjustable in terms of cycle, frequency, output voltage waveform, output current waveform or a combination thereof; and
the traveling-wave electric field is configured to be adjustable in terms of amplitude, positive-to-negative amplitude ratio and traveling-wave propagation speed.

In an embodiment, the charged particles are selected from the group consisting of antibodies, protein-based molecules, microcapsules, vesicles, nanomedicines, cells, cellular components and a combination thereof.

The present disclosure provides a charged particle control method, the method being performed based on the aforementioned device, and the method comprising:
(a) introducing a fluid containing charged particles into the microfluidic channel;
(b) correspondingly connecting the plurality of conductor leads to the at least two drive power supplies; and
(c) controlling each of the at least two drive power supplies to periodically output the voltage excitation or the current excitation, so as to form the traveling-wave electric field in the microfluidic channel; and
controlling, under the action of the traveling-wave electric field, the charged particles to move in the microfluidic channel;
wherein the traveling-wave electric field has a periodically-varying amplitude; the traveling-wave electric field is configured to move at the preset traveling-wave propagation speed, and apply the force to the charged particles to generate the migration velocity perpendicular to the flow direction of the fluid; the migration velocity is correlated with the charge-to-mass ratio of the charged particles; and the maximum charge capacity of each of the at least three electrodes is greater than the total amount of charges transferred thereon during the single charging or discharging process.

Compared to the prior art, the present disclosure at least has the following beneficial effects.
(1) Compared to traditional electrodes, the device and the method provided herein address problems of electrolytic reaction occurring at the electrode to fundamentally avoid the bubble generation. Moreover, the disclosure also avoids the electrode passivation after long-term operation.
(2) Compared to other novel electrodes, the disclosure overcomes the charge capacity limitation, and has advantages of excellent long-term operational stability, strong electric current drive, and sufficient miniaturization to provide enough driving force at micron and nanometer scales.
(3) The disclosure demonstrates the following advantages over the traditional electrophoresis technologies: (i) suitable for miniaturization; (ii) precise control of forward/backward movements of the charged particles in the electrolyte; and (iii) accurate control of charged particles with micron and nanometer scales.
(4) Compared to dielectrophoresis, the disclosure exhibits higher efficiency, and a lower driving voltage to manipulate high-velocity charged particles. Moreover, the disclosure enables the drive of charged particles with micron and nanometer scales, and precise control of the movement of the charged particles (the distortion of the local electric field gradient in dielectrophoresis will greatly affect the control accuracy).

### BRIEF DESCRIPTION OF THE DRAWINGS

In order to illustrate the technical solutions in the embodiments of the present disclosure or in the prior art more clearly, the accompanying figures needed in the description of the embodiments of the present disclosure or in the prior art will be briefly described below. Obviously, presented in the accompanying figures are merely some embodiments of the present disclosure. Other accompanying figures can also be obtained by those skilled in the art based on the figures provided herein without paying creative effort.

FIG. 1a schematically shows a device for controlling charged particles in a fluid according to an embodiment of the present disclosure;

FIG. 1b is a sectional view of the device in FIG. 1a along an A-A direction;

FIG. 2 schematically shows an output voltage of a drive power supply according to an embodiment of the present disclosure;

FIG. 3 schematically shows an output current of an electrode according to an embodiment of the present disclosure;

FIG. 4 schematically shows electrostatic force decomposition according to an embodiment of the present disclosure;

FIG. 5a schematically shows a device for controlling charged particles in a fluid according to another embodiment of the present disclosure;

FIG. 5b is a sectional view of the device in FIG. 5a along an A-A direction;

FIG. 6 schematically shows an output voltage of a drive power supply according to another embodiment of the present disclosure;

FIG. 7 schematically shows separation of to-be-treated sample according to an embodiment of the present disclosure; and

FIG. 8 schematically shows enrichment of the to-be-treated sample according to an embodiment of the present disclosure.

In the figures: 1—microfluidic channel; 11—first port; 12—second port; 13—charged particle; 2—electrode; and 3—drive power supply.

### DETAILED DESCRIPTION OF EMBODIMENTS

The present disclosure will be clearly and completely described below with reference to the accompanying figures in the embodiments. Obviously, described below are merely some embodiments of the present disclosure, not all embodiments. Based on the embodiments in the present disclosure, all other embodiments obtained by those of ordinary skill in the art without paying creative labor shall fall within the scope of the present disclosure.

The present disclosure provides a device and method for controlling charged particles in a fluid. By using a plurality of double-layer capacitances, a plurality of pseudo-capacitances and a combination thereof, a traveling-wave electric field is introduced to a fluid containing charged particles, so as to enable the operation and control of the charged particles. Each of at least three electrodes is configured to continuously undergo alternating cycles of charging and discharging to form a reciprocating current, and an output charge of each of the at least three electrodes is less than a charge capacity thereof, thereby avoiding an electrochemical reaction at the electrode-electrolyte interface. Since the traveling-wave electric field has different influences on the charged particles with different charge-to-mass ratios, the charged particles can be precisely manipulated and controlled by precisely controlling an amplitude and a traveling-wave propagation speed of the traveling-wave electric field.

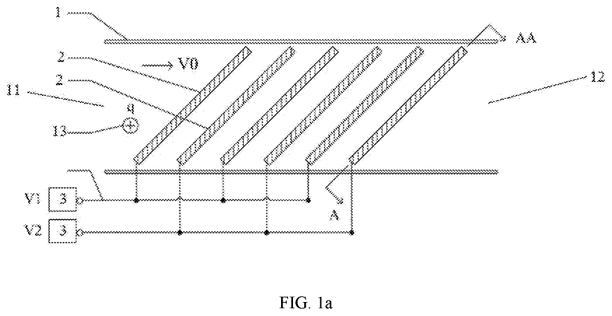

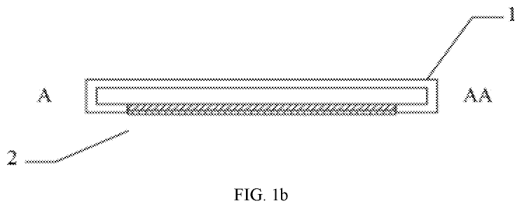

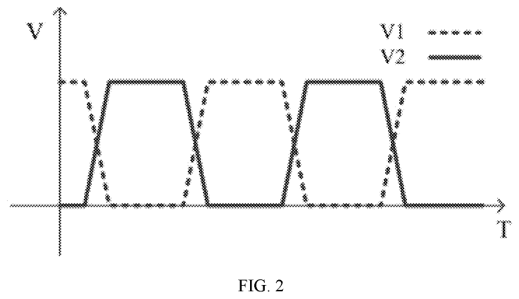

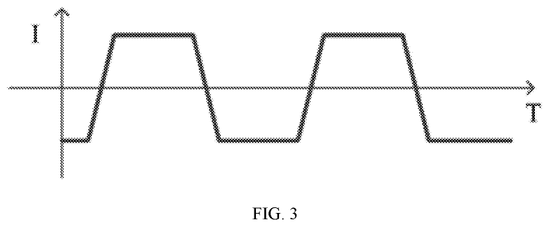

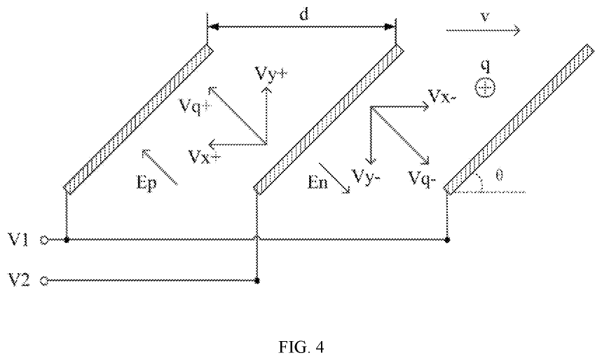

A device for controlling charged particles in a fluid according to an embodiment of the present disclosure is schematically shown in FIG. 1a. A sectional view of the device in FIG. 1a along an A-A direction is shown in FIG. 1b. An output voltage of a drive power supply according to an embodiment of the present disclosure is schematically shown in FIG. 2. An output current of an electrode 2 according to an embodiment of the present disclosure is schematically shown in FIG. 3. An electrostatic force decomposition according to an embodiment of the present disclosure is schematically shown in FIG. 4.

Referring to FIGS. 1a-4, the present disclosure provides a device for controlling charged particles in a fluid. The device includes a microfluidic channel 1, at least three electrodes 2, a plurality of conductor leads (not shown in FIGS. 1a-4) and at least two drive power supplies 3.

In some embodiments, the microfluidic channel 1 is provided with a first port 11 and a second port 12. The first port 11 and the second port 12 are configured to allow the fluid to flow from the first port 11 towards the second port 12. The fluid contains the charged particles 13.

In some embodiments, the fluid includes a buffer solution and a heterogeneous fluid. The charged particles 13 are solid, gas or liquid, and are selected from the group consisting of antibodies, protein-based molecules, microcapsules, vesicles, nanomedicines, cells, cellular components and a combination thereof. The charged particles 13 are positively charged or negatively charged.

In some embodiments, the fluid is configured to flow from the first port 11 towards the second port 12 at a flow velocity of V0.

In some embodiments, each of the at least three electrodes 2 is in electrical contact with the fluid to form a pseudo-capacitance, a double-layer capacitance and a combination thereof at a fluid-electrode interface. The at least three electrodes 2 are arranged in parallel on the same side or opposite sides of the microfluidic channel 1. There is an inclined angle formed between an arrangement direction of each of the at least three electrodes 2 and a flow direction of the fluid. The inclined angle is defined that the arrangement direction of each of the at least three electrodes 2 is neither parallel to nor perpendicular to the flow direction of the fluid, but rather between “parallel” and “perpendicular”. As shown in FIG. 4, the inclined angle is represented by θ.

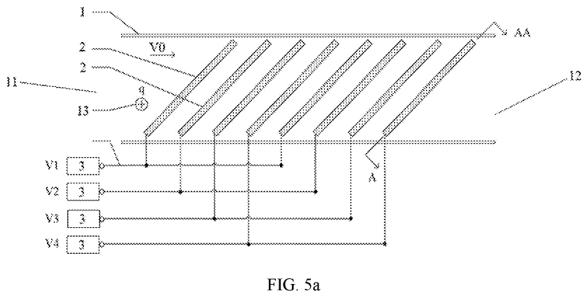

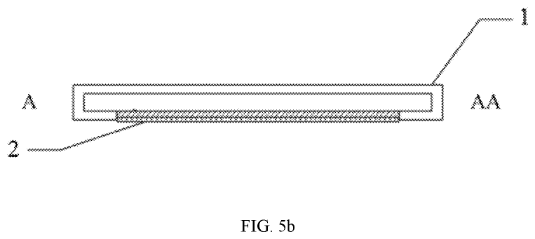

In some embodiments, one side of the microfluidic channel 1 is provided with the at least three electrodes 2, which indicates that the other side of the microfluidic channel 1 is not provided with the at least three electrodes 2. Referring to the embodiments in FIG. 1a, FIG. 4 and FIG. 5a, the at least three electrodes 2 are arranged based on such an arrangement.

In some embodiments, two sides of the microfluidic channel 1 are simultaneously provided with the at least three electrodes 2, which can be expanded based on the aforementioned arrangement. A principle thereof is the same as that of the embodiments provided in FIG. 1a, FIG. 4 and FIG. 5a. Therefore, it will not be elaborated herein.

In some embodiments, each of the at least three electrodes 2 is in electrical contact with the fluid to form a pseudo-capacitance, the double-layer capacitance and a combination thereof at the fluid-electrode interface, thereby fundamentally addressing the problem of bubble generation caused by the conductor electrode.

In some embodiments, each of the at least two drive power supplies 3 is configured to periodically output a voltage excitation or a current excitation. The voltage excitation or the current excitation is configured to dynamically vary within a single output cycle. Each of the at least two drive power supplies 3 is connected to at least one electrode 2 among the at least three electrodes 2 via the at least one conductor lead among the plurality of conductor leads. Each of the at least two drive power supplies 3 is configured to be adjustable in terms of cycle, frequency, output voltage waveform, output current waveform or a combination thereof.

In some embodiments, each of the at least three electrodes 2 is configured to continuously undergo alternating cycles of charging and discharging to form a traveling-wave electric field with a periodically-varying amplitude in the microfluidic channel 1. The traveling-wave electric field is configured to move at a preset traveling-wave propagation speed and apply a force to the charged particles to generate a migration velocity perpendicular to the flow direction of the fluid, where the migration velocity is correlated with a charge-to-mass ratio of the charged particles. A maximum charge capacity of each of the at least three electrodes 2 is greater than a total amount of charges transferred thereon during a single charging or discharging process.

In some embodiments, the microfluidic channel 1 has a characteristic length ranging from 100 nm to 10 mm, where the characteristic length is defined that an inner diameter of the microfluidic channel 1. The charged particles 13 each have a characteristic length ranging from 0.1 nm to 0.1 mm, where the characteristic length is defined that a diameter of a charged particle 13.

In some embodiments, within one or more cycles of the traveling-wave electric field, for each of the at least three electrodes 2, a total input current is equal to a total output current, which indicates that a net input current and a net output current on each of the at least three electrodes 2 are both zero. Or within one or more cycles of the traveling-wave electric field, for each of the at least three electrodes 2, a total input charge and a total output charge are always less than a charge capacity.

In some embodiments, the traveling-wave electric field is configured to be adjustable in terms of amplitude, positive-to-negative amplitude ratio and preset traveling-wave velocity propagation speed.

Referring to the embodiment of FIG. 1a, the number of the drive power supplies 3 is two. The two drive power supplies 3 presented in FIG. 1a each have an output voltage, which are respectively expressed as V1 and V2 as shown in FIG. 2. For each of the at least three electrodes 2, those connected to the at least two drive power supplies 3 with the output voltage V1 is configured as one group, and those connected to the at least two drive power supplies 3 with the output voltage V2 is configured as the other group.

Referring to the embodiment of FIGS. 1a-1b, there are two groups of the at least three electrodes 2.

In some embodiments, more groups of the at least three electrodes 2 can be arranged.

Referring to FIG. 2, at different times, voltage differences between V1 and V2 are exactly opposite in magnitude, thus forming an electric field that periodically reverses its direction between the at least three electrodes 2. For example, within one cycle T, during a first T/2 cycle, a given voltage is applied to V1 while V2 is held at zero, thereby forming a forward electric field at the electrode 2. During a second T/2 cycle, V1 is held at zero while the given voltage is applied to V2, thereby forming a reverse electric field at the electrode 2.

An output current of an electrode 2 according to an embodiment of the present disclosure is schematically shown in FIG. 3. The electrode 2 described in FIG. 3 is represented by an electrode 2 on the far left as shown in FIG. 1a. The output current is configured to flows from an electrode 2 with a higher voltage to an electrode 2 with a lower voltage. In this case, the higher voltage and the lower voltage are relative to each other. When an electrode 2 has a higher voltage, the electrode 2 operates in an anode mode, where an output current of the electrode 2 is positive, and flows from the electrode 2 to an adjacent electrode 2 with a lower voltage. When an electrode 2 connected to the at least two drive power supplies 3 with the output voltage V1 has a zero voltage, the electrode 2 has a zero output current. It indicates that there is neither current flowing in nor flowing out of the electrode. When an electrode 2 connected to the at least two drive power supplies 3 with the output voltage V1 has a lower voltage, the electrode 2 operates in a cathode mode, where an output current of the electrode 2 is negative, and flows into the electrode 2. It should be indicated that the voltage of the electrode 2 that dynamically varies with time causes the electrode 2 to undergo reciprocating cycles of charging and discharging to form a reciprocating current.

Referring to FIG. 3, the output current I of the electrode 2 on the far left shown in FIG. 1a has an average of zero in a single cycle. Moreover, an output current I of each of the at least three electrodes 2 has an average of zero in a single cycle. It indicates that if a direction of an output current I of the electrode 2 is forward during a first T/2 cycle, a direction of an output current I of the electrode 2 is reversed during a second T/2 cycle while maintaining the same magnitude, thereby causing the output current I of the electrode 2 has an average of zero in a single cycle. In other words, each of the at least three electrodes 2 merely needs a charge capacity that sufficiently supplies a half-cycle current. Consequently, the present disclosure adopts each of the at least three electrodes 2 that needs an extremely small charge capacity to satisfy requirements of normal operation.

Referring to FIG. 1a, the number of the at least two drive power supplies 3 is two. The output voltages of the two drive power supplies 3 are respectively expressed as V1 and V2 as shown in FIG. 2. Based on a voltage variation shown in FIG. 2, an electric field Eₚ and an electric field Eₙ are generated between each of the at least three electrodes 2 during the first T/2 cycle and the second T/2 cycle, respectively. A strength of the electric field Eₚ is the same as a strength of the electric field Eₙ. A direction of the electric field Eₚ and a direction of the electric field Eₙ are opposite to each other, where the electric field Eₚ is a forward electric field, and the electric field Eₙ is a reversed electric field. The electric field Eₚ and the electric field Eₙ are configured to alternate every T/2 cycle. Referring to FIG. 4, the strength of the electric field Eₚ satisfies formula Eₚ=(V2−V1)/(d*cos(θ)), and the strength of the electric field Eₙ satisfies formula Eₙ=(V1−V2)/(d*cos(θ)).

The electric field Eₚ and the electric field Eₙ apply a force to the charged particles, thereby enabling the charged particles to move relative to the fluid. In addition, the charged particles move at a flow velocity V0 of the fluid. By changing the voltage of each of the at least three electrodes 2, the electric field Eₚ and the electric field Eₙ are controlled in terms of strength, direction, duration, thereby controlling the migration velocity, migration direction and spatial distribution of the charged particles, enabling the control of the charged particles, and precisely screening and distinguishing the charged particles.

Referring to FIG. 4, the electric field Eₚ and the electric field Eₙ apply an electrostatic force to the charged particles q in the microfluidic channel 1, so as to allow the charged particles q to generate a migration velocity V_{q+}/V_{q-}proportional to a strength of an electric field and a charge-to-mass ratio of the charged particles, respectively.

Each of the at least three electrodes 2 are arranged in parallel. There is an inclined angle θ formed between an arrangement direction of the at least three electrodes 2 and the flow velocity V0 direction of the fluid. In the electric field Eₚ (the direction of the electric field Eₚ is configured as a positive direction), the migration velocity V_{q+}is decomposed into a first decomposition velocity Vₓ₊and a second decomposition velocity V_{y+}. A direction of the first decomposition velocity Vₓ₊is parallel to the direction of the flow velocity V0 (i.e., the direction of Vₓ₊is parallel to a X-direction). A direction of the second decomposition velocity V_{y+}is perpendicular to the direction of the flow velocity V0 (i.e., the direction of V_{y+}is parallel to a Y-direction). Correspondingly, in the electric field Eₙ, the migration velocity V_{q-}is decomposed into a third decomposition velocity Vₓ₋and a fourth decomposition velocity V_{y-}. A direction of the third decomposition velocity Vₓ₋is parallel to the direction of the flow velocity V0 (i.e., the direction of Vₓ₋is parallel to the X-direction). A direction of the fourth decomposition velocity V_{y-}is perpendicular to the direction of the flow velocity V0 (i.e., the direction of V_{y-}is parallel to the Y-direction).

Given that the fluid moves at a constant velocity and the flow velocity V0 remains constant, a moving velocity of the charged particles relative to each of the at least three electrodes 2 is expressed as V0+Vₓ₊ within the duration of the electric field E_{q}, such that the charged particles have a displacement expressed as V_{y+}*(d/(V0+Vₓ₊)), along a direction perpendicular to the direction of the flow velocity V0. In the above formula, (d/(V0+Vₓ₊)) represents a time that it takes for each of the charged particles to move along the X-direction through a distance of d between the at least three electrodes 2. A moving velocity of the charged particles relative to the at least three electrodes 2 is expressed as V0−Vₓ₋ within the duration of the electric field Eₙ, such that the charged particles have a displacement expressed as V_{y-}*(d/(V0−Vₓ₋)), along a direction perpendicular to the direction of the flow velocity V0.

Given that Vₓ₊ and Vₓ₋ are equal in magnitude and opposite in direction, under the action of the electric field Eₚ and the electric field Eₙ, the charged particles have different migration velocities V_{q} (V_{q+}/V_{q-}). Although V_{y+} and V_{y-} are equal in magnitude and opposite in direction, the electric field Eₚ and the electric field Eₙ have different durations. Consequently, the charged particles move along the direction perpendicular to the direction of the flow velocity V0. A moving velocity magnitude of the charged particles along the direction is determined by many parameters, including the strength of the electric fields Eₚ, the strength of the electric fields Eₙ, the charge-to-mass ratio of the charged particles, coefficient of liquid sticking, the inclined angle θ of each of the at least three electrodes 2, the flow velocity V0, and the distance d between the at least three electrodes 2.

After passing through the electric field Eₚ and the electric field Eₙ, the charged particles with different charge-to-mass ratios controllably move along the direction perpendicular to the direction of the fluid velocity V0. A movement amplitude of the charged particles is independent of a sequential order in which Eₚ and Eₙ are applied. Therefore, the sequential order of Eₚ and Eₙ can be periodically alternated as needed, which is equivalent to periodically alternating the output voltages V1 and V2. By means of this, the reciprocating current is merely supplied to the fluid at each of the at least three electrodes 2. Under the condition of a constant amplitude of the electric field, each of the at least three electrodes 2 has a lower requirement for the charge capacity by reducing an alternation cycle. The alternation cycle is typically configured to be not less than V0/(2*d).

An amplitude of the output voltage V1 and an amplitude of the output voltage V2 are respectively adjusted, such that a magnitude of the electric field E_{q}, a magnitude of the electric field Eₙ, a waveform of the electric field E_{q} and a waveform of the electric field Eₙ are respectively adjusted, so as to enable the precise control of the charged particles with different charge-to-mass ratios in the electrolyte.

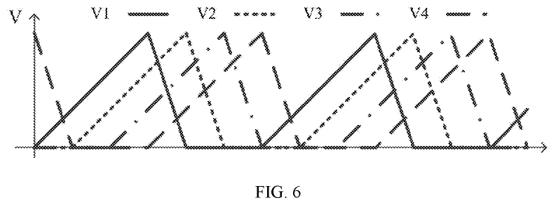

A device for controlling charged particles in a fluid according to another embodiment of the present disclosure is schematically shown in FIG. 5a. A sectional view of the device in FIG. 5a along an A-A direction is shown in FIG. 5b. An output voltage of a drive power supply according to another embodiment of the present disclosure is schematically shown in FIG. 6. Another embodiment is described below with reference to FIGS. 5a-6. The differences from the aforementioned embodiments in FIG. 1a and FIG. 4 are illustrated below.

Compared to the aforementioned embodiment, this embodiment has the most significant difference as follows.
(1) The aforementioned embodiment is provided with two groups of the at least three electrodes 2, but this embodiment is provided with four groups of the at least three electrodes 2.
(2) The output voltage of the at least two drive power supplies 3 in the aforementioned embodiment is shown in FIG. 2, but the output voltage of the at least two drive power supplies 3 in this embodiment is shown in FIG. 6.

Based on a voltage waveform of the at least two drive power supplies 3 this embodiment, an electric field that periodically reverses its direction is formed between the at least three electrodes 2. The principles including the variation in electric field strength and the moving velocity of charged particles due to the electrostatic force are consistent with those described in the aforementioned embodiment. For those skilled in the art, the principles can be obtained according to calculation methods in the aforementioned embodiment. For the sake of brevity, there is no elaboration herein.

The present disclosure at least has the following applications.
(1) Separation of to-be-treated sample

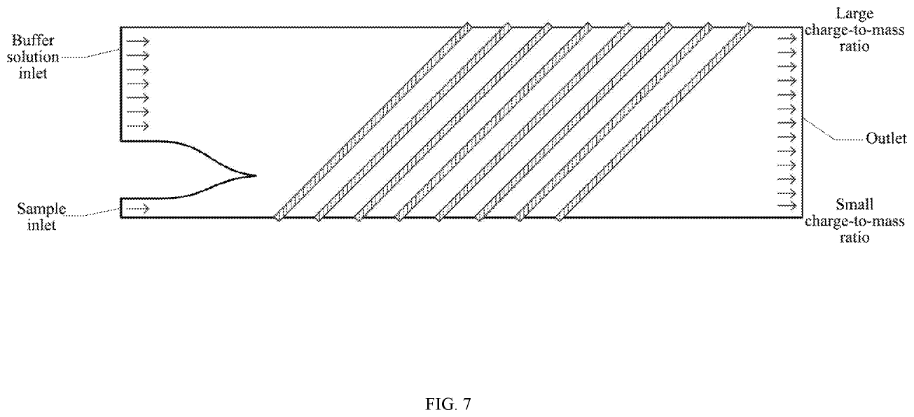

The charged particles with different properties in the fluid are subjected separation and/or purification. Separation of to-be-treated sample according to an embodiment of the present disclosure is schematically shown in FIG. 7.

(2) Enrichment of to-be-treated sample

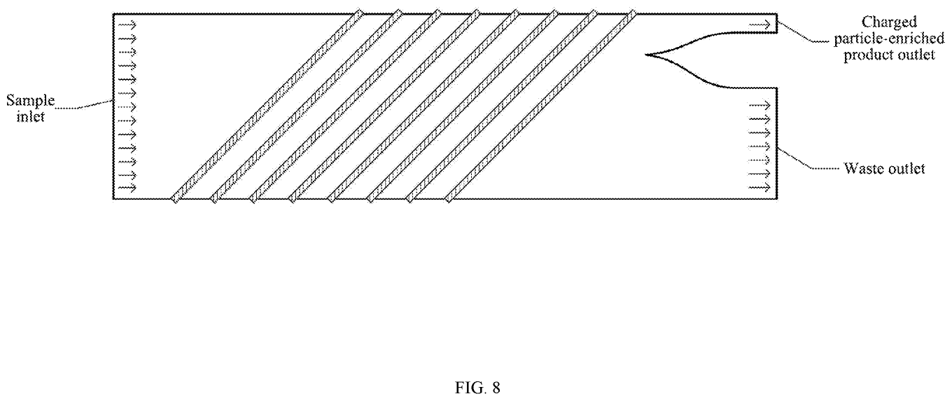

The charged particles with specific properties in the fluid are subjected enrichment. Enrichment of to-be-treated sample according to an embodiment of the present disclosure is schematically shown in FIG. 8.

A device for separating the to-be-treated sample is shown in FIG. 7. The buffer solution and the to-be-treated sample are simultaneously added into the first port 11. The charged particles in the to-be-treated sample are controlled by the traveling-wave electric field to move, where the traveling-wave electric field is formed between the at least three electrodes 2. The charged particles with different charge-to-mass ratios generate different migration velocities in the traveling-wave electric field. Consequently, after the charged particles with different properties in the to-be-treated sample flow through the traveling-wave electric field, the charged particles are enriched and distributed at different positions perpendicular to the flow direction of fluid due to different charge-to-mass ratios. Under a specific configuration, it can be observed that the charged particles with a larger charge-to-mass ratio are enriched and distributed at an upper portion of the second port 12, while the charged particles with a smaller charge-to-mass ratio are enriched and distributed at a lower portion of the microfluidic channel 1. By means of this, the charged particles with different charge-to-mass ratios are arranged from top to bottom, thereby enabling separation of the charged particles with different charge-to-mass ratios. At the second port 12 (an output port of the charged particles), a plurality of collection ports are arranged at different positions along a vertical direction to collect different types of the charged particles.

A device for enriching the to-be-treated samples is shown in FIG. 8. The to-be-treated samples are input into the first port 11. When the to-be-treated sample containing the charged particles flows through the microfluidic channel 1, the charged particles with different charge-to-mass ratios generate different migration velocities along a vertical direction by applying an alternating current in space and time to the traveling-wave electric field formed by a plurality of groups of the at least three electrodes 2. The charged particles are selected from the group consisting of microparticles, nanoparticles, antibodies, protein-based molecules, vesicles, cells and a combination thereof. As shown in FIG. 8, when the charged particles with different charge-to-mass ratios in the to-be-treated sample flow through the traveling-wave electric field of the device, the charged particles with different charge-to-mass ratios are subjected to different driving forces to generate different displacements. The charged particles with a larger charge-mass ratio are enriched at an enrichment outlet due to larger displacements along the vertical direction. Therefore, the charged particles with larger charge-mass ratio, having a higher distribution concentration, are obtained at the enrichment outlet, thereby achieving enrichment of specific charged particles in the to-be-treated sample. Specifically, when the to-be-treated sample contains a specific type of charged particles with lower concentration, the device shown in FIG. 8 is configured to control these charged particles, thereby improving their concentration at the enrichment outlet and outputting them from the enrichment outlet.

It should be noted that the devices shown in FIGS. 7-8 can be used individually or connected in series.

In some embodiments, in the separation device shown in FIG. 7, it is configured such that charged particles with charge-to-mass ratios k₁₀ and k₁ are enriched and distributed at a bottom and at a top, respectively, of the second port 12 of the separation device (first-stage separation device). Afterward, a fluid containing charged particles with charge-to-mass ratios ranging from k4 to k5 is output from a middle of the second port 12, and passes through another identical separation device (second-stage separation device). The amplitude and propagation speed of the traveling-wave electric field in the second-stage separation device are configured to meet a requirement that charged particles with charge-to-mass ratios ranging from k₃ to k₆ are uniformly distributed from a bottom to a top of the second port 12. In this way, charged particles with charge-to-mass ratios ranging from k_{4.4} to k_{4.5} are obtained at a local position. By following this principle, identical separation devices can be additionally cascaded downstream, thereby performing step-by-step separation.

In some embodiments, in the enrichment device shown in FIG. 8 (first-stage enrichment device), by setting a specific strength of the traveling-wave electric field, charged particles with charge-to-mass ratios greater than k₁ are obtained from the enrichment outlet. Subsequently, a waste-liquid outlet of the enrichment device is connected to an identical device (second-stage enrichment device) for next enrichment. The strength and traveling-wave propagation speed of the traveling-wave electric field in the second-stage enrichment device is configured to meet a requirement that charged particles with charge-to-mass ratios greater than k₂ are further separated from a waste liquid output by the waste-liquid outlet of the first-stage enrichment device. By following this principle, identical separation devices can be additionally cascaded downstream, thereby performing step-by-step separation.

The present disclosure provides a charged particle control method, which is performed based on the aforementioned device, and includes the following steps.
(1) The fluid containing charged particles is introduced into the microfluidic channel.
(2) The plurality of conductor leads is correspondingly connected to the at least two drive power supplies 3.
(3) Each of the at least two drive power supplies 3 is controlled to periodically output the voltage excitation or the current excitation, so as to form the traveling-wave electric field in the microfluidic channel. Under the action of the traveling-wave electric field, the charged particles are controlled to move in the microfluidic channel.

The traveling-wave electric field has a periodically-varying amplitude. The traveling-wave electric field is configured to move at the preset traveling-wave propagation speed, and apply the force to the charged particles to generate the migration velocity perpendicular to the flow direction of the fluid. The migration velocity is corelated with the charge-to-mass ratio of the charged particles. A maximum charge capacity of each of the at least three electrodes 2 is greater than the total amount of charges transferred thereon during the single charging or discharging process.

Compared to the prior art, the present disclosure at least has the following beneficial effects.
(1) Compared to traditional electrodes, the device and the method provided herein address problems of electrolytic reaction occurring at the electrode 2 to fundamentally avoid the bubble generation. Moreover, the disclosure also avoids the electrode passivation after long-term operation.
(2) Compared to other novel electrodes, the disclosure overcomes the charge capacity limitation, and has advantages of excellent long-term operational stability, strong electric current drive and sufficient miniaturization to provide enough driving force at micron and nanometer scales.
(3) The disclosure demonstrates the following advantages over the traditional electrophoresis technologies: (i) suitable for miniaturization; (ii) precise control of forward/backward movements of the charged particles in the electrolyte; and (iii) accurate control of charged particles with micron and nanometer scales.
(4) Compared to dielectrophoresis, the disclosure exhibits higher efficiency, and a lower driving voltage to manipulate high-velocity charged particles. Moreover, the disclosure enables the drive of charged particles with micron and nanometer scales, and precise control of the movement of the charged particles (the distortion of the local electric field gradient in dielectrophoresis will greatly affect the control accuracy).

It should be understood that for those skilled in the art, each of the accompanying figures is a schematic diagram of an embodiment, and modules or processes in the accompanying figures are not necessarily required for the implementation of the embodiments of the present disclosure.

It should be understood that for those skilled in the art, the modules of the device presented in the embodiments can be arranged in the device according to the description of the embodiments, and can also be arranged in at least one device according to other ways different from those disclosed herein. The modules can be combined with each other to form an integrated module, or be further divided into a plurality of sub-modules.

It should be noted that the embodiments described above are merely illustrative, and are not intended to limit the present disclosure. Although the disclosure has been described in detail above with reference to the embodiments, for those skilled in the art, various modifications and equivalent replacements can still be made to the technical solutions and features recited in the embodiments. It should be understood that those modifications and replacements made without departing from the spirit of the present disclosure shall fall within the scope of the disclosure defined by the appended claims.

What is claimed is:

1. A device for controlling charged particles in a fluid, comprising:
a microfluidic channel;
at least three electrodes;
a plurality of conductor leads; and
at least two drive power supplies;
wherein the microfluidic channel is provided with a first port and a second port; the first port and the second port are configured to allow the fluid to flow from the first port towards the second port; and the fluid contains the charged particles;
each of the at least three electrodes is in electrical contact with the fluid to form a pseudo-capacitance, a double-layer capacitance or a combination thereof at a fluid-electrode interface; the at least three electrodes are arranged in parallel on the same side or opposite sides of the microfluidic channel; and an arrangement direction of the at least three electrodes is neither parallel nor perpendicular to a flow direction of the fluid;
each of the at least two drive power supplies is configured to periodically output a voltage excitation or a current excitation; the voltage excitation or the current excitation is configured to dynamically vary within a single output cycle; and each of the at least two drive power supplies is connected to at least one electrode among the at least three electrodes via the at least one conductor lead among the plurality of conductor leads; and
each of the at least three electrodes is configured to continuously undergo alternating cycles of charging and discharging to form a traveling-wave electric field with a periodically-varying amplitude in the microfluidic channel; the traveling-wave electric field is configured to move at a preset traveling-wave propagation speed, and apply a force to the charged particles to generate a migration velocity perpendicular to the flow direction of the fluid, wherein the migration velocity is correlated with a charge-to-mass ratio of the charged particles; and a maximum charge capacity of each of the at least three electrodes is greater than a total amount of charges transferred thereon during a single charging or discharging process.

2. The device of claim 1, wherein the fluid comprises a buffer solution and a heterogeneous fluid.

3. The device of claim 2, wherein the first port comprises a first inlet and a second inlet; the first inlet is configured to allow the buffer solution to flow into the microfluidic channel; the second inlet is configured to allow the heterogeneous fluid to flow into the microfluidic channel; and the first inlet is arranged above the second inlet.

4. The device of claim 2, wherein the second port comprises a first outlet and a second outlet; the first outlet is configured to discharge a charged particle-enriched product; the second outlet is configured to discharge a waste liquid; and the first outlet is arranged above the second outlet.

5. The device of claim 1, wherein the microfluidic channel has an inner diameter ranging from 100 nm to 10 mm.

6. The device of claim 1, wherein the charged particles each have a diameter ranging from 0.1 nm to 0.1 mm.

7. The device of claim 1, wherein within one or more cycles of the traveling-wave electric field, for each of the at least three electrodes, a total input current is equal to a total output current, indicating that a net input current and a net output current on each of the at least three electrodes are both zero; or
for each of the at least three electrodes, a total input charge and a total output charge are always less than the maximum charge capacity.

8. The device of claim 1, wherein each of the at least two drive power supplies is configured to be adjustable in terms of cycle, frequency, output voltage waveform, output current waveform or a combination thereof; and
the traveling-wave electric field is configured to be adjustable in terms of amplitude, positive-to-negative amplitude ratio and traveling-wave propagation speed.

9. The device of claim 1, wherein the charged particles are selected from the group consisting of antibodies, protein-based molecules, microcapsules, vesicles, nanomedicines, cells, cellular components and a combination thereof.

10. A charged particle control method, the method being performed based on the device of claim 1, and the method comprising:
(a) introducing a fluid containing charged particles into the microfluidic channel;
(b) correspondingly connecting the plurality of conductor leads to the at least two drive power supplies; and
(c) controlling each of the at least two drive power supplies to periodically output the voltage excitation or the current excitation, so as to form the traveling-wave electric field in the microfluidic channel; and
controlling, under the action of the traveling-wave electric field, the charged particles to move in the microfluidic channel;
wherein the traveling-wave electric field has a periodically-varying amplitude; the traveling-wave electric field is configured to move at the preset traveling-wave propagation speed, and apply the force to the charged particles to generate the migration velocity perpendicular to the flow direction of the fluid; the migration velocity is correlated with the charge-to-mass ratio of the charged particles; and the maximum charge capacity of each of the at least three electrodes is greater than the total amount of charges transferred thereon during the single charging or discharging process.
